(19) United States
(12) Patent Application Publication
(10) Pub. No.: US 2021/0040790 A1
(43) Pub. Date: Feb. 11, 2021

(54) DOOR SEALS WITH RODENT RESISTANT BARRIER; MOUNTING AND SHIELDING STRIPS FOR THE MOUNTING OF SUCH SEALS AND FOR THE PROTECTION OF DOOR LEAVES; MOUNTING TOOLS FOR MOUNTING SUCH DOOR SEALS AND MOUNTING AND SHIELDING STRIPS; ASSEMBLIES INCLUDING SUCH DOOR SEALS; METHODS FOR RODENT PROOFING DOORS AND PROTECTING DOOR LEAVES

(71) Applicant: Rodexit ApS, Holte (DK)

(72) Inventors: Bjørn VON RYBERG, Holte (DK); Claus FRIMAND, Holte (DK)

(21) Appl. No.: 16/611,970

(22) PCT Filed: Dec. 20, 2018
(86) PCT No.: PCT/DK2018/050412

§ 371 Date: Nov. 8, 2019

(30) Foreign Application Priority Data
Dec. 22, 2017 (DK) PA201700744
Jan. 8, 2018 (DK) PA201800009
Mar. 12, 2018 (DK) PA201870153
Apr. 13, 2018 (DK) PA201800160
May 28, 2018 (DK) PA201800238

(51) Int. Cl. E06B 7/22; A01M 29/30

(52) U.S. Cl. CPC E06B 7/22; A01M 29/30

(57) ABSTRACT

A flexible and oblong blade seal for sealing a gap between a door leaf and an adjacent surface including a flexible outer material and a section with the sealing function in which a barrier of a plurality of substantially parallel metal wires and/or narrow metal strips is embedded in the flexible outer material. The wires and/or strips are arranged in parallel to the longitudinal direction of the seal, where at least a part of at least one of the metal wires/or strips is provided with 3 or more stable bends The bends selected from a curve-shaped bend, a bulging deformation, a wave-shaped bend and a wave-like deformation.

Door seals with rodent resistant barrier; mounting and shielding strips for the mounting of such seals and for the protection of door leaves; mounting tools for mounting such door seals and mounting and shielding strips; assemblies including such door seals; methods for rodent proofing doors and protecting door leaves.

### TECHNICAL FIELD

The disclosure relates to oblong blade seals and seal assemblies for sealing a space A) between a building part—e.g. an edge of a door leaf—and an adjacent surface B) between a wall and an adjacent surface and/or C) between a fence and an adjacent surface in particular for sealing the threshold gaps of doors to avoid entrance of for example unwanted animals, insects, or water—especially unwanted rodents such as rats and mice. The unwanted water may include sewage water, rain water and water from flooding. The seals and seal assemblies may also help in controlling the physical atmosphere within a room behind the door by restricting air drafts and by reducing heat transfer so that the interior may be more effectively heated or cooled. The disclosure also relates to A) separate mounting and shielding strips for mounting said seals on door leaves and for protecting the door leaves, B) a tool for mounting said seals and said mounting and shielding strips, and C) methods for at the same rodent proofing doors and protecting door leaves by mounting said door seals and mounting and shielding strips.

### BACKGROUND

A general problem of building design relates to the dual issues of excluding inclement weather and animals or vermin from entering or impacting the interior when the entryway is shut. There is a need for better door seals. The seal according to the aspects of the disclosed embodiments meet this need. Compared with existing seals it furthermore presents a considerable number of other substantial advantages. Below these advantages are explained in further detail.

### DISCLOSURE

The seal according to the aspects of the disclosed embodiments are an oblong blade seal of a flexible outer material with a rat and/or mice resistant barrier made of a plurality of elongated metal members in the form of A) metal wires, B) narrow metal strips or C) a combination of metal wires and narrow metal strips embedded in the part of the seal with the sealing function (the sealing section), where the elongated metal members are arranged at a distance to each other and substantially in parallel to the longitudinal direction of the seal and where at least one of the elongated metal members is provided with 3 or more bends.

### A. Terminology

The expressions “door leaf”, “door wing”, “door panel” and (when used about a double door) “door half” are used interchangeably and mean one and the same thing, namely the e.g. board shaped part of the door, which moves when opening and closing the door.

The expression “the threshold bap” means the gap between the bottom edge of a door leaf in closed position and the underlying surface.

The expression “the threshold bottom surface” means the bottom surface of the threshold gap.

The expressions “door sill” and “threshold” are used interchangeably and mean one and the same thing namely a board or the like mounted under a door leaf in order to provide A) a suitable bottom surface of the threshold gap and B) a protruding edge, against which the door leaf can press when closed.

The expressions “the front of a door” and “the front of a door leaf” means the side of the door/door leaf pointing in the direction, in which the door opens.

The expressions “the backside of a door” and “the backside of a door leaf” means the side of the door/door leaf pointing in the direction, in which the door closes.

The expression “in front of a door” means in front of the front of the door.

The expression “the overpassed ground” means the ground in front of a door which is overpassed by the door leaf when the door is opened and closed.

“Elongated metal members” means A) metal wires, including flexible multi stranded metal wires, such as braided or twisted wires and single stranded wires, B) narrow metal strips, and C) combinations of metal wires and narrow metal strips.

“Manual doors” are doors, which are opened and closed by human muscle power.

“Motorized doors” are doors, which are opened and closed by means of some sort of motor power. All automatic doors are motorized. Some hand-controlled doors are motorized. Many motorized doors are equipped with a security stop mechanism, which can stop the closing of the door, when the hand of a person or some other obstacle is detected by a sensor.

“Automatic doors” are motorized doors which are opened and closed automatically by a movement sensor, when it senses someone coming sufficiently close to the door.

“Hand controlled doors” are doors which are opened and closed by a person e.g. by pressing a button—as opposed to automatically by a movement sensor. All manual doors are hand controlled. Some motorized doors are hand controlled.

### B. The Main Door Sealing Problem and the Minimum Requirements for its Proper Solution

When a hinged swing door has been mounted in a building there will often be a significant gap between the bottom edge of the door leaf in closed position and the threshold bottom surface, i.e. a significant threshold gap. There are primarily 3 reasons for that:
Firstly, it is desirable that the door leaf can pass unhindered over small obstacles in front of the door without being blocked, when the door is opened and closed. Such obstacles may e.g. be the ground in front of the door sloping negatively towards the door or a stone accidently lying in front of the door.
Secondly the threshold bottom surface may be slanting. E.g. the left side may be 15 mm lower than the right side, and if the door is correctly mounted and the bottom of the door leaf therefore is horizontal, then the threshold gap will have to be least 15 mm higher on the left side than on the right side.
Thirdly, it is necessary to have a threshold gap of a certain height because there always is a risk that the position of the door leaf will be changed downwards as times goes by and the building, the door and/or the hinges settles.

A significant threshold gap does unfortunately cause problems. It cannot keep out pests, wind and water. Furthermore, it is an undesirable thermal bridge. Such problems can often be reduced substantially by mounting a threshold with a protruding edge, towards which the lowermost part of the door leaf can press when in closed position. In many cases that is, however, not a useful option. This is e.g. not the case when goods are to be transported in and out of the door on pallet jacks. For in such cases a threshold would soon get smashed. Furthermore, the goods would often drop from the pallet jack, when it was to pass over the threshold. For these reasons there is very often in many shops a door to the storage room with a significant threshold gap without any compensating threshold.

Such significant threshold gaps without compensating thresholds is a big problem, especially because it provides free access for rats and mice. Thus, a rat only needs 20 mm in order to enter under a door leaf and a mice can do with as little as 6 mm.

Rats and mice are capable of transmitting very dangerous contagious diseases, which can be transferred to humans via foods. Therefore, food enterprises are in many countries subject to one or more of the following requirements, which are aimed at reducing the risk for transfer of diseases to humans, when a rat or mouse has entered the premises of the food enterprise: A) The rat or mouse must be caught. B) All foods, which the rat or mouse may have been in contact with, must be destroyed. C) All parts of the enterprise, with which the rat or mouse may have been in contact, must be disinfected. D) The enterprise must close until the problem has been thoroughly solved.

Solving the problem is usually very costly and may run into several hundred thousand USD. Therefore, the annual losses due to rats and mice entering food enterprises are extremely high.

Although the main problem with rats and mice entering buildings through insufficiently sealed threshold gaps of doors has been known for more than a century there is still a substantial need for a better solution. In many countries the standard solution is for example the mounting of door seals in the form or high-density brushes integrated in a mounting strip of aluminum even though it is well known that they cannot keep out rats and mice.

The reason why the main problem has not been solved effectively long ago in spite of the seriousness and economic impact of the problem is undoubtedly, that an effective solution has to live up to a number of requirements, which are hard to meet simultaneously. Thus, when the door is a hinged swing door and the threshold gap is to be secured against rats and mice, an effective door seal must live up to the following minimum requirements:
1. The door seal must be so flexible round the horizontal plane (i.e. around an axis parallel to the bottom edge of the door leaf) so it can pass over any obstacles in front of the door, when the door is opened and closed.
2. The door seal must furthermore be so flexible round the horizontal plane that it even after many thousand slow or fast passages over an obstacle will return to its original form.
3. Even though the door seal must be flexible it must not be so soft that a rat or mouse can push it up and/or to the side and thereby pass the door leaf. This requires substantially less flexibility round the vertical plane (i.e. perpendicular to the bottom edge of the door leaf) than round the horizontal plane when the door seal is mounted.
4. There has to be some sort of barrier, even a rat with its very strong and special rodent teeth, which keep growing through the entire lifetime of the rat, cannot gnaw to pieces.
5. When the door is a double door with two door leaves, the two door seals mounted on the door leaves shall not only cover the two threshold gaps under the two door leaves but also the gap between the two threshold gaps, i.e. the gap under the astragal gap between the two door leaves, and that must be achieved without using a stiff mounting strip of metal or the like sticking out into the astragal gap, where there is a risk that such a protruding stiff mounting strip may hit and hurt people passing through the door.
6. The door seal must be so durable that it can stand many thousand door openings and closings without being prematurely worn out and this must be the case even if there is some sort of more or less permanent obstacle in front of the door.

It is far from obvious how one can at the same time meet all the above requirements. The door seal described in the international patent application PCT/DK2017/050401 constitutes a major step in the right direction. However, as explained in relation to the 2^{nd} aspect in section 4.G below there is room for improvement especially in relation to the proofing of the threshold gap of hinged swing doors and to some extent also the threshold gap of folding doors and rotating doors.

The solution according to the aspects of the disclosed embodiments have been tested. The tests covered both durability and ability to resist prolonged attacks from rats. The tests were successful, and it is, therefore, substantiated that the aspects of the disclosed embodiments actually does solve the main problem in an effective way.

### C. Advantages—Other than the Solution to the Main Door Sealing Problem

It is of course a substantial advantage that the main problem has been solved in a satisfactory way. On top of that the aspects of the disclosed embodiments offer several other advantages.

For example, when the doors are hinged swing doors and the door seals are mounted horizontally on the bottom parts of the door leaves in order to seal their underlying threshold gaps, the door seals according to one or more embodiments of the first and second aspects of the disclosed embodiments have the following other advantages compared to one or more of the door seals presently on the market:
1. The door seal can in its entirety be produced from two cheap standard materials e.g. A) ordinary solid single-stranded steel wire and B) thermoplastic elastomer pellets (TPE).
2. The door seal can be produced in a single extrusion and bending process by means of standard extrusion equipment and that is a very effective and cheap form of production.
3. The extruded door seal does not require any further processing—of course apart from the adaption to the measures of the door leaf, on which it is to be mounted.
4. The door seal can be mounted both with and without a mounting strip. Thus, it can e.g. be mounted by means of ordinary and cheap facade screws, which can be screwed through the door list and into the door leaf.
5. If a user wishes to mount the door seal with a mounting strip, the user is not bound to use any particular kind of mounting strip, in which the door seal is integrated. The user can freely choose any mounting strip, which live up to the user's individual requirements such as aesthetic, regulatory, or practical requirements. E.g. The user can choose a very sturdy mounting strip, which can protect the lower part of the door leaf against damaging forces such as the impact from collisions with heavy pallet lifters.
6. When a door seal according to the present disclosure is mounted with a separate mounting strip, the mounting strip can be reused, as it does not constitute an integrated part of the door seal. Thereby, costs can be reduced and waste can be avoided to the benefit of both the user and the environment.
7. The door seal according to the present disclosure can with ordinary metal scissors in just of few seconds and quite easily be adapted to the door leaf, on which it is to be mounted. This is especially an advantage compared to the traditional door seals with an integrated mounting strip of aluminum, where one has to use a hacksaw, an angle grinder or the like to shorten the door seal, and where there is a risk of losing bristles when shortening a high density brush door seal.
8. The door seal can be rolled into a relatively compact roll. E.g. a 3 mm thick, 75 mm broad and 25 m long door seal with 10 single stranded solid steel wires measuring 1 mm in diameter and without any integrated mounting strip can easily be rolled into a 75 mm broad roll with a diameter of only 40 cm. This is an appreciable advantage when one has to store or transport door seals. E.g. in the back of a carpenter's van it is far easier to administrate a small 7.5×40×40 cm box than 25 separate 1 meter long traditional door seals with an integrated mounting strip of aluminum.
9. The door seals on the market are sold in relatively short standard measures e.g. 1 and 2.5 m. Unavoidable this leads to a substantial waste, when the door seals are shortened in connection with the adaption to the concrete door leaves, on which they are to be mounted, and the superfluous stump it thrown away—to the detriment of the environment. Such waste can be almost eliminated when using the door seal according to the aspects of the disclosed embodiments A) as is can easily be stored and transported in very long rolls e.g. 25 m rolls and B) the user can cut off exactly the length needed for each door leaf, so the only waste is the very last piece which is too short for being mounted on a door.
10. The door seal according to the present disclosure can be extruded or insert molded with a smooth surface, which is easy to clean effectively. This is a substantial advantage especially compared with the traditional high-density brush door seals, which tend to accumulate lots of dirt between the bristles, and which are quite impossible to clean effectively.
11. When a traditional high-density brush door seal accumulates dirt the bristles get stiff and sticky and clot together, and when this happens the high density brush gradually loses its sealing properties. The door seal according to the present disclosure does not suffer from this problem.
12. The basic structure of the door seal according to the present disclosure is very solid. Therefore, the door seal is very resistant to violent impacts such as kicks even if it is mounted without a protecting mounting strip.
13. In cases where the door leaf will be subject to heavy impacts from pallet jacks and the like, the user can choose A) to mount the door seal according to the present disclosure with a broad and solid mounting strip made of steel and B) to mount the mounting strip in a way which gives good protection to the door seal as well as the door. With traditional door seals, which are produced with a relatively fragile integrated mounting seal typically made of aluminum, the user does not have that option.
14. The last e.g. 5 cm of the right or left end part of a horizontally mounted door seal according to the present disclosure can easily be bend round a substantially vertical axis in an angel of about 90 degrees. Such a bend can e.g. with a screw be fastened to the hinged edge of the door leaf (the edge on which the hinges are mounted) or the leading edge of the door leaf (the edge on the side of the door leaf with the door handle). This means A) that the part of the threshold gap i) along the bottom of the hinged edge and ii) along the bottom of the leading edge can be sealed with an unbroken seal, which at the same time seals the threshold gap along the bottom of the frontside or the backside of the door leaf, and B) that this does not require any strenuous and technically weak assembly of multiple parts. It is of course a condition for this, that there is sufficient room in the gaps between the door leaf and the door jambs. However, that will often be the case as e.g. a 4 mm gap will be sufficient for a 3 mm thick door seal. This ability to seal the threshold gap along the bottom of the hinged edge and the leading edge of the door leaf is of great importance when it comes to keeping mice out, as they can enter through said parts of the threshold gap if one of the 2 gaps between the door leaf and the 2 door jambs is 6 mm or more. A traditional door seal with an integrated stiff mounting strip cannot be mounted in the same way.
15. In cases where there isn't the necessary gap between the leading edge and the adjacent lock door jamb, which is mentioned in the preceding paragraph, the door seal can as an alternative to the mounting mentioned in the preceding paragraph be mounted on the front of the door leaf with an end of the door seal protruding from the door leaf and A) covering the lowermost part of the gap between the leading edge of the door leaf and the adjacent lock door jamb and B) maybe even overlapping the lowermost part of the adjacent lock door jamb. This is an operational solution because of the flexible nature of the door seal, as the flexibility makes it unlikely that the protruding portion of the door seal can hurt anyone passing through the door. This way of mounting does not provide a sealing as effective as the one described in the preceding paragraph, but it is better than the mounting of traditional door seals on the front of the door leaf only without any protruding end parts. Likewise, the door seal can be mounted on the backside of a door leaf with a protruding end part A) covering the lowermost part of the gap between the hinged edge of the door leaf and the adjacent hinge door jamb and B) maybe even overlapping the lowermost part of the adjacent hinge door jamb. A traditional door seal with an integrated stiff mounting strip should not be mounted in the same way as the protruding part of the metal strip can hurt persons passing through the door.
16. If the threshold bottom surface is irregular the bottom edge of the door seal can with metal scissors easily be adapted so it fits the irregularities.
17. The door seal according to the present disclosure is a continuous and unbroken barrier. It is therefore much better at hindering draft and protecting against high and low outdoor temperatures than the traditional high density brush door seals, where the wind relatively easy can pass between the bristles of the brush.
18. When the door seal according to the present disclosure has been produced with elongated metal members in the whole width of the door seal without any integrated mounting strip, and the door seal has been worn out, the worn out door seal can be reused by inverting it so the sealing section becomes the mounting section and vice versa. This is especially relevant when the door seal is mounted by means of a separate mounting strip, as the separate mounting strip will cover the worn out former sealing section when the door seal has been remounted.
19. The door seal can be made with elongated metal members of spring steel. That will add further elasticity to the door seal thereby reinforcing some of the advantages. Firstly, it will make the door seal more resistant to violent impacts. Secondly, when the door seal is mounted with protruding end parts, it will reduce the risk of such protruding end parts hurting persons passing through the door.

The above is for presentation purposes limited to hinged swing doors. However, the aspects of the disclosed embodiments have a broader field of application and can with several of the abovementioned advantages also be used for other doors including bifold doors, folding doors and rotating doors.

### D. An Unexpected Problem and its Solution

On the face of it one would think that ordinary solid and single stranded steel wires is the logical and best choice when choosing elongated metal members for a door seal according to the present disclosure. This is because A) such wires provide better protection against rat attacks than multi stranded wires consisting of a plurality of much thinner and less gnaw resistant steel wires and B) such wire is a cheap standard product which can be bought in the form of 5 or 2.3 km long coils, which are very suitable for being used in an extrusion process.

However, the surface of ordinary solid and single stranded steel wires is smooth and in a practical implementation it has unexpectedly been found that this may generate a problem under very special circumstances. Thus, when a door seal according to the present disclosure with such smooth wires has been mounted horizontally on the bottom part of a hinged door in order to secure the threshold gap, and the door seal several thousand times hits a serious obstacle in front of the door during the opening and closing of the door, some of the lowest positioned of the wires (closest to the threshold bottom surface) may gradually be forced out of one end of the door seal. The same problem may arise when the door seal is mounted on the door leaves of bifold doors, folding doors and rotating doors.

There are several ways, in which this problem may be solved or at least reduced. In the international patent application PCT/DK2017/050401 the following is suggested:
1. At least a part of the lowermost 2.5 cm of the door seal may be provided with a fastener, which from both sides of the door seal sets said part of the door seal under pressure thereby increasing the friction between the wires and the flexible outer material. Examples of useful fasteners are A) rivets and B) screw bolts and nuts mounted through the door seal e.g. with a washer on each side of the door seal. Another example is clips.
2. One or both end parts of the horizontally mounted door seal may be provided with a bend of 60 to 180 degrees round a substantially vertical axis—preferably a bend of about 90 or about 180 degrees. A suitable length of the bent end part(s) may be 3-10 cm, such as 4-8 cm, such as about 5 cm. Each bend end part may be secured to the hinged edge or the leading edge of the door leaf, while the unbent main part of the door seal is mounted on the front or the back of the door leaf—especially if the bend is about 90 degrees. The bend may be in the whole width of the door seal but may also be limited to e.g. the lowermost part of the door seal e.g. the lowermost 25, 15 or 10 mm, in which case the bent lowermost part must in some way must be separated from the uppermost part of the door seal e.g. by cutting away the corresponding uppermost part. A vertical 180 degrees bend may be secured by means of A) a rivet, B) a screw or C) a screw bolt going through both layers of the door seal and into the door leaf. It may also be secured by means of A) a rivet or B) a screw bolt with a nut mounted through both layers of the bent part of the door seal e.g. with a washer on each side of the door seal. Furthermore, it may be secured by a clip. It may also be secured by a mounting strip pressing the bent end part of the door seal against the door leaf and thereby holding the 180 degrees bend in position.
3. At least a part of at least one of the metal wires may be provided with 3 or more stable bends such as 3 stable bends selected from: a) a curve-shaped bend, b) a bulging bend and c) a wave-shaped bend. The bends will increase the friction between the wires and the flexible outer material in the longitudinal direction of the wires.
4. The wires or at least the lowermost 2-3 wires may be coated with a primer—e.g. a zinc chromate primer—or another sort of adhesive coating e.g. a brass alloy coating, to which the flexible outer material adheres better than to the raw steel wire.
5. Wires with an uneven surface may be used instead of wires with a smooth surface as the rougher surface will provide more friction between the wires and the flexible outer material. This alternative choice may be limited to the lowermost 1-3 wires in order to keep costs low. Such wires with an uneven surface may be A) multi stranded wires or B) ordinary solid single stranded wires which have been deformed and thereby provided with an uneven and rougher surface by means of a mechanical or chemical process. One such method of mechanically deforming a solid single stranded wire is to let the wire pass between two wheels of hardened steel A) with a smaller distance between the wheels than the diameter of the wire and B) with an in relation to the longitudinal direction of the wire substantially transverse pattern, which is imprinted into the wire as it passes between the two wheels. A solid single stranded wire may also be deformed by shot blasting, sand blasting, glass blasting or chemical surface treatment such as sporadic treatment with a strong acid.

The above on how to solve the unexpected problem associated with the use of solid single stranded wires with a smooth surface apply mutatis mutandis to narrow metal strips with a similar smooth surface.

As explained below in section 4.G in relation to the 2^{nd} aspect there has been invented an alternative and more effective way of solving the problem.

### E. Door Seals for Electronically Controlled Doors and Doors with Uneven or Rough Threshold Bottom Surfaces

Electronically controlled doors such as automatic hinged swing doors and automatic sliding doors are normally equipped with a safety function, which stops the opening or closing of the door, if during the opening or closing an unusually resistance is registered. This is because such an unusual resistance may be caused by a person being hit by the opening or closing door leaf.

When a door seal according to the present disclosure is mounted on such an electronically controlled door, the bottom part of the door seal may during opening or closing of the door come in contact with the threshold bottom surface or the overpassed ground in such a way, that it generates so much friction and resistance, that the safety function is triggered, and the opening or closing stops. This is not desirable. In order to solve this problem, the door seal must be equipped with something that reduces the friction and resistance without at the same time giving unrestricted access for pests and the wind. A solution to the problem is to secure short brushes or fibers to the bottom part of the door seal or to integrate the short brushes or fibers in the bottom part of the door seal. It may be integrated by means of a slot formed in the flexible outer material, in which a brush strip can fit.

A brush strip or fiber strip may also be secured to the door seal e.g. by means of a slot in the flexible outer material in order to make the door seal better at sealing indentations in an uneven or rough threshold bottom surface.

### F. 1St Aspect—Flexible Door Seal with an Embedded Rat and Mice Secure Barrier

According to a first aspect of the disclosed embodiments there is provided an oblong blade door seal of a flexible outer material comprising a plurality of substantially parallel elongated metal members in the form of A) metal wires, B) narrow metal strips or C) combinations of metal wires and narrow metal strips embedded in the flexible outer material with the elongated metal members arranged substantially in parallel to the longitudinal direction of the seal and at some distance to each other. The main purpose of the seal is to repel A) animals such as rodents including mice and rats B), insects, and C) water. The seal may also help in controlling the physical atmosphere within a building by restricting air drafts, so the interior may be more effectively heated or cooled. The purpose of the elongated metal members is to secure against rodents such as rats and mice gnawing their way through the seal. The elongated metal members do in other words serve as a barrier.

In a possible implementation form, the seal comprises a first section intended to seal a space or gap (the sealing section) and a second section (the mounting section) to be mounted on a door in a building. The mounting section may be made of another material than the sealing section and may be with or without the embedded elongated metal members, while the sealing section must be with a plurality of the embedded elongated metal members. The structure of the seal may be symmetric with an entirely uniform structure so there is no apparent difference between the sealing section and the mounting section and it is up to the user to decide which part the user wishes to use as the mounting section for mounting purposes.

FIG. 1 is a partially cut away perspective view of a flexible seal 101 according to a first example embodiment, and FIG. 2 is a partially cut away perspective view of a flexible seal 201 according to a second example embodiment.

Each of the seals 101 and 201 has a flexible outer material with a first side part 102a, 202a and a second side part 102b, 202b encompassing a plurality of embedded metal wires 103, 203, where each of the wires 103, 203 run substantially in parallel to each other. The flexible seals 101, 201 have a longitudinal extension, and the metal wires 103, 203 run substantially in the longitudinal direction of the seal 101, 201. The substantially parallel metal wires 103, 203 are arranged at a distance to each other, and it is preferred that the metal wires 103, 203 are arranged with a substantially equal spacing. It is preferred that the flexible outer material 102a, 102b, 202a, 202b encompasses the embedded parallel metal wires 103, 203 only.

The upper part of the seal 101 with the uppermost 4 metal wires may serve as the mounting section while the lower part with the lowermost 5 metal wires may serve as the sealing section and vice versa.

The flexible outer material 102a, 102b, 202a, 202b may have a flattened form with a substantially constant or uniform thickness. The flexible outer material 102a, 102b, 202a, 202b may be made of a material selected from: A) a flexible polymer or plastic material, such as flexible polyvinyl chloride, PVC, and/or a flexible rubber material B) a flexible polymer material, which may be a material comprising a natural polymer material such as rubber and/or a synthetic polymer material such as synthetic rubber or a thermoplastic material or a polyvinyl chloride, PVC, material, and C) a thermoplastic elastomer (TPE) such as a thermoplastic vulcanizate (TPV)—e.g. Santoprene™, such as Santoprene™ 201-73.

The ratio between the thickness of the flexible outer material 102a, 102b, 202a, 202b and the Shore A hardness score of the flexible outer material (indirectly reflecting the flexibility of the material) may be in such a way that the result of a multiplication of the predominant thickness in mm by the Shore A score is a number in the range of 175-275, such as 190-275, such as 200-260, such as 210-250 such as 220-240.

The flexible outer material may have a thickness in the range of 2 to 30 mm, such as in the range of 2 to 20 mm, such as in the range of 2 to 10 mm, such as in the range of 2 to 5 mm, such as in the range of 2.5 to 4 mm, such as about 3 mm. The Shore A hardness score of the outer flexible material may be 45-90 such as 60-90, such as 65-88 such as 70-85, such as about 78.

The wires 103, 203 may be arranged at a distance to each other which is no larger than 20 mm, such as no larger than 19 mm, such as no larger than 18 mm, such as no larger than 17 mm, such as no larger than 15 mm, such as no larger than 12 mm, such as no larger than 10 mm, such as no larger than 9 mm, such as no larger than 8 mm, such as no larger than 7 mm, such as no larger than 6 mm, such as no larger than 5 mm, such as no larger than 4 mm, such as no larger than 3 mm, or such as no larger than 2 mm.

In a possible implementation form at least part of the wires 103, 203 in the sealing section are arranged at a distance to the nearest wire (i.e. to the neighboring wire) being no larger than 20 mm, such as no larger than 19 mm, such as no larger than 18 mm, such as no larger than 17 mm, such as no larger than 15 mm, such as no larger than 12 mm, such as no larger than 10 mm, such as no larger than 9 mm, such as no larger than 8 mm, such as no larger than 7 mm, such as no larger than 6 mm, such as no larger than 5 mm, such as no larger than 4 mm, such as no larger than 3 mm, or such as no larger than 2 mm.

In order to use the seals 101, 201 as a seal barrier for vermin and pests, such as rats or mice, the wires shall be dimensioned and made of a material, which the rats and/or mice cannot bite their way through. Thus, the wires shall have a thickness and be made of a material, which the rats and/or mice cannot bite through, and also the distance between the wires shall be so small, that the rats and/or mice cannot move in between the wires, even if they gnaw off the flexible outer material.

The wires 103, 203 or some of them may be made of a selection of the following materials or alloys thereof: a) iron b) steel c) stainless steel d) spring steel e) welding wire filler metal such as 308L, 316L, 309L and 347 filler metal. The wires 103, 203 or some of them may a) be flexible multi stranded metal wires, such as braided or twisted wires with a natural uneven surface or b) single stranded wires with a smooth surface or an uneven surface. The metal wires 103, 203 or some of them can also be narrow metal strips having a width, which may be substantially equal to the thickness of the narrow metal strips, or in the range of one to three times the thickness of the narrow metal strips.

When using spring steel for the metal wires 103, 203 the seal 101, 201 gets an improved resistance against strokes or collisions. Moreover, a protruding part of a mounted seal with wires of spring steel is less likely to harm passing persons because of the extra flexibility and bending qualities.

The wires 103, 203 may have a thickness or diameter equal to or no less than 0.4 mm, equal to or no less than 0.6 mm, equal to or no less than 0.7 mm, equal to or no less than 0.8 mm, equal to or no less than 0.9 mm, equal to or no less than 1 mm, equal to or no less than 1.1 mm, equal to or no less than 1.2 mm, equal to or no less than 1.3 mm, equal to or no less than 1.4 mm, equal to or no less than 1.5 mm, equal to or no less than 1.6 mm, equal to or no less than 1.7 mm, equal to or no less than 1.8 mm, equal to or no less than 1.9 mm, equal to or no less than 2.0 mm, equal to or no less than 2.1 mm, equal to or no less than 2.2 mm, equal to or no less than 2.4 mm, equal to or no less than 2.7 mm, or equal to or no less than 3 mm.

When the wires 103, 203 are metal strips, the metal strips may have a width equal to or no less than 0.6 mm, equal to or no less than 0.8 mm, equal to or no less than 1 mm, equal to or no less than 1.5 mm, equal to or no less than 2 mm, or equal to or no less than 2.5 mm.

The seals 101, 201 may have a width in the range of 1.5 to 30 cm, such as in the range of 2 to 25 cm, such as in the range of 2 to 20 cm, such as in the range of 2 to 15 cm, such as in the range of 4 to 10 cm, such as in the range of 5 to 9 cm, such as about 6 cm or about 8 cm.

By having the metal wires 103, 203 running substantially in parallel, the seal 101, 201 can relatively easily bend or flex around an axis substantially parallel to the metal wires 103, 203 and the longitudinal direction of the seal, while bending or flexing around an axis perpendicular to the parallel metal wires 103, 203 and the longitudinal direction of the seal will also be possible but to a lesser extent. The flexibility around the axis parallel to the longitudinal direction of the blade seal is substantially larger than the flexibility around the axis perpendicular to the longitudinal direction of the seal.

The main difference between the first seal 101 and the second seal 201 is that for the first seal 101, metal wires 103 are provided at a distance to each other in the whole width of the seal 101, while for the second seal 201, only a part of the seal 201 has metal wires 203 running substantially parallel to each other.

When using the flexible seal 201 mounted with a separate or integrated mounting strip on a door, it is not necessary to have metal wires in the mounting section. Thus, there is only need for having metal wires in the sealing section.

It is preferred that the mounting section of the seal 201 has a maximum width equal to or no less than one fifth of the maximum width of the sealing section, equal to or no less than one quarter of the maximum width of the sealing section, equal to or no less than one third of the maximum width of the sealing section, equal to or no less than half of the maximum width of the sealing section, equal to or no less than two thirds of the maximum width of the sealing section, equal to or no less than three quarters of the maximum width of the sealing section, or equal to or no less than the whole width of the sealing section.

In a specific embodiment the seal 201 has a total width of about 75 mm, the width of the sealing section is 58 mm, the mounting section has a width of 17 mm, and the width from the bottom of the seal 201 to the lowermost metal wire 203 is 3 mm. Here, the seal 201 has a thickness of 3 mm, the metal wires are made of 308L welding wire with a diameter of 1 mm, the distance between neighboring metal wires 203 is about 5 mm, and the total number of metal wires is 10.

In a specific embodiment the seal 101 has a total width of about 60 mm and the distance from each of the edges of the seal 101 to the nearest metal wire 103 is about 3 mm. The seal 101 has a thickness of 3 mm. The metal wires 103 are made of stainless spring steel with a diameter of 1 mm. The distance between neighboring metal wires 103 is about 5 mm, and the total number of metal wires is 10.

It is within an embodiment of the disclosure that the distance from the lowermost arranged metal wire 103, 203 to the lower edge of the seal 101, 201 is smaller than the distance between neighboring arranged metal wires 103, 203. Thus, the distance from the lowermost arranged metal wire 103, 203 to the lower edge of the seal 101, 201 may be in the range of ⅔ to ⅓ or about half or below half of the distance between neighboring arranged metal wires 103, 203. If the wires 103, 203 for example are arranged at a distance to each other, which distance is at least 4 mm, such as 4 mm or 5 mm the distance from the lowermost arranged metal wire 103, 203 to the lower edge of the seal 101, 201 may be about 2 mm. If the wires 103, 203 are arranged at a distance to each other about 5 mm, the distance from the lowermost arranged metal wire 103, 203 to the lower edge of the seal 101, 201 may be about 2 mm or 3 mm or in the range of 2-3 mm.

The flexible seals 101, 201 may have been produced by a single extrusion process or in a single insert molding process, in which case the first side parts 102a and 202a and the second side parts 102b and 202b constitute one single outer material, in which the wires 103, 203 are embedded. One material may be used for the sealing section and another for the mounting section. If so, one of the materials must be provided by on ore more inlets to the extruder or the mold while one or more other inlets must be used for providing the other material in such a way that one of the materials ends up in the sealing section and the other material ends up in the mounting section. The profile of the extruded seal is determined by the design of the outlet part of the extrusion die. Each of the wires may be fed into the extrusion die in the same way as wires are fed into an extrusion die when producing plastic covered electric cables. The crosshead extrusion process which is widely used for coating wires and cables may be used.

In a possible implementation form, the number of metal wires 103, 203 in the seal 101, 201 is at least 2, such as at least 3, such as at least 4, such as at least 5, such as at least 6, such as at least 7, such as at least 9, such as at least 10, such as at least 11, such as at least 13.

The number of metal wires 103, 203 in the sealing section is at least 2, such as at least 3, such as at least 4, such as at least 5, such as at least 6, such as at least 7, such as at least 9, such as at least 10.

In a possible implementation form of the seal 101, there are at least 2 metal wires 103 in the mounting section, such as at least 3, such as at least 4, such as at least 6, such as at least 8. One purpose of the wires in the mounting section is to reinforce the section in order to make mounting without a mounting strip an operational option e.g. so it becomes possible to mount the seal 101 securely by means of facade screws with screw heads spanning over at least two neighboring wires embedded in the mounting section. Another purpose is to make it possible to reuse a used seal 101 with a worn out or damaged sealing section by inverting it, so the former mounting section becomes the sealing section with a barrier of metal wires 103, and the former sealing section becomes the mounting section with reinforcing wires 103.

The flexible seals 101, 201 may be integrated into a stiff mounting strip of metal such as aluminum. However, it is preferred that they are not integrated into such a stiff mounting strip. The flexible seals 101, 201 may have a smooth and easy to clean surface.

One side of the mounting section of the seal 101, 201 may be provided with double sided tape which can hold the seal in place during the mounting process A) so the user does not need to use one hand for holding the door seal in place while mounting and B) the user can use both hands for handling tools, fasteners and—if the seal is to mounted with a separate mounting strip—a mounting strip.

The elongated metal members of FIGS. 1 and 2 (103 and 203) are straight. They may be bend as shown in FIG. 3 (300).

A brush strip or fiber strip may as described in section 4.E be secured to the door seal (101 or 201) e.g. by means of a slot in the flexible outer material (102a, 102b, 202a and 202b).

In FIG. 4 the seal 401 has been provided with markings 402 indicating recommended positions for placing fasteners such as screws, rivets, screw bolts and nails. The seal is a seal like 101 of FIG. 1 with wires embedded in the mounting section. The marks are placed between two neighboring metal wires. There are two marks 402 for each 10 cm in the longitudinal direction of the seal—one in the upper part of the seal and one in the lower part of the seal. The distance between each set of two markings could be 3-30 cm, such as 4-25 cm, such as 5-15 cm, such as 8-12 cm, such as about 10 cm. When using the recommended positions, the user can place the fasteners 100% consistently a) without use of any time-consuming measuring and b) without any risk of hitting the embedded metal wires. The marks 402 in the upper part may be used when first mounting the seal on a door by means of e.g. facade screws. The marks 402 in the lower part may be used when remounting the seal 401 after the lower sealing section has been worn out or damaged and the seal 401 is to be inverted and reused with the former lower sealing section as the upper mounting section and vice versa. The marks 402 may be made of ink or another material placed on the surface of the seal. The marks 402 may also be in the form of imprints in the outer flexible material of the seal 401. Such imprints can be made during the extrusion process if the seal 401 is extruded. During the extrusion process they can be made by 2 imprinting wheels—one on each side of the seal 401 putting it under pressure and imprinting the marks and any other characters placed on the outer perimeter of the wheels into the flexible outer material of the seal 401. Substantially in the middle between the 2 longitudinal edges of the seal 401 there is a continuous band of letters and other characters 403. The band of characters 403 may be used for marketing purposes e.g. by displaying a logo or trademark. It does, however, primarily serve a purely technical purpose, as a continuous band of characters on the perimeter of both imprinting wheels provides the friction between the 2 wheels and the outer flexible material, which is necessary for making the wheels turn automatically as the seal 401 passes between the 2 wheels. It is preferred that there are identical markings 402 for recommended fastener positions on both sides of the seal 401, so it does not matter how the user turns the seal 401 the first time it is to be mounted.

### G. 2^{nd} Aspect—Flexible Door Seal with an Embedded Rat and Mice Secure Barrier and with Stable Bends

The object of the aspects of the disclosed embodiments are achieved in accordance with a second aspect by providing a seal according to any of the possible implementation forms of the first aspect for sealing a space between an edge of a door (e.g. the edge of a door leaf) and an adjacent surface such as the threshold gap of a hinged swing door, a bifold door, a folding door, or a rotating door. The door may be a manual door, an automatic motorized door or a hand operated motorized door.

An implementation form of this second aspect is illustrated in FIG. 5, which is an isometric illustration of a lower edge door sealing assembly 500 according to an example embodiment, and in FIG. 6, which is an enlarged isometric illustration of a part of the lower edge door sealing assembly 500 of FIG. 5.

The seal assembly 500 of FIGS. 4 and 6 is arranged for sealing a space between a lower edge of a door 507 and an adjacent surface 510 (i.e. for sealing the threshold gap). The seal assembly 500 comprises a flexible seal 501, which may be of the types 101 or 201 as described in connection with FIGS. 1 and 2 or any of the implementation forms of the 1st and 2^{nd} aspect. The seal assembly 500 may have at least one connecting plate 506, which may be made of steel, stainless steel, springs steel or aluminum, and which connects the flexible seal 501 to the edge of the door leaf 507. The connecting plate may be a separate mounting strip or a mounting strip, in which the flexible seal has been incorporated. The seal 501 may be connected to the door leaf 507 by gluing.

By having the flexible end parts 504a and 504b, the flexible seal 501 can be arranged with the end parts 504a, 504b protruding from one or on both sides of the door leaf edge, to thereby obtain a close seal to the lower part of the frame of the door (i.e. of the 2 door jambs).

The adjacent threshold bottom surface 510 may be a ground surface, a floor surface, a concrete surface, a threshold or a door sill and the gap may be the threshold gap. The adjacent surface may also be a door jamb. Furthermore, if the door is a double door with 2 door leaves the adjacent surface may also be the other door leaf.

The door leaf (507) may be the door leaf A) of a hinged swing door, a bifold door, a folding door or a rotating door, and B) of a manual door, an automatic motorized door or a hand operated motorized door.

The connecting plate (506) may be a mounting strip of any of the implantation forms of the 5th aspect described in section 4.J.

The assembly may comprise an elongated brush strip mounted in a slot formed in the flexible outer material of the door seal.

### Example 4.G.1

A specific implementation form of the assembly could comprise:
1) The door leaf of a manual exterior single hinged swing door.
2) The blade door seal of example 4.G.2 with an integrated slot formed in the outer flexible material said door seal being mounted on the lower part of the backside of the door leaf.
3) The mounting and shielding strip of example 4.J.1.
4) An elongated brush strip mounted in said integrated slot formed in the outer flexible material.

When a straight (not bend) door seal with a barrier of solid single stranded wires is mounted on the bottom of the door leaf of a hinged swing door in order to seal the threshold gap, it is as previously described an unexpected problem, that there under very special circumstances is a risk that the lowermost wires may be forced out of an end of the door seal. Similar problems may be experienced when such door seals are mounted in a similar way on a folding door, on a bifold door or on a rotating door. The problem may arise both when the door is a manual door and when it is motorized.

The problem may be solved or at least reduced if the friction between the lowermost wires and the flexible outer material is increased e.g. by securing better adhesion of the flexible outer material to the wires. One way of obtaining this is to use solid single stranded wires with an uneven surface e.g. wires with a deformed surface. FIG. 7 show an example of such a deformed solid single stranded wire 701 with grooves 702 substantially perpendicular to the longitudinal direction of the wire. Instead of a deformed solid single stranded wire a multi stranded wire with its natural uneven surface may be used. Another way of obtaining better adhesion is to use solid single stranded wires with an at least partly coated or primed surface. Thus, the surface of solid single stranded wires may be at least partly deformed, roughed, or surface treated e.g. at least partly fluted or grooved, chemically treated or etched, sandblasted, glass bead blasted, shot blasted, chromate coated, coated by a deformed coating material, coated by an adhesive coating, such as a brass alloy coating or coated by a primer coating such as a zinc chromate primer. The adhesion may also be improved by heating the wires to around 200 degrees Celsius just before extruding or insert molding the door seal.

The problem may also be solved or at least reduced by bending at least one part of the door seal, as this can also provide an increased friction between wires and outer flexible material. FIG. 8 illustrates a door seal 801 like the seal 101 of FIG. 1, which has been provided with a bend 802. The bending angle is about 90 degrees and the seal has been bent substantially perpendicular to the longitudinal direction of the door seal. The door seal has been bent in one end only. However, the seal can also be bent in both ends. The door seal 801 is by means of facade screws 803 mounted on a door leaf 804 without use of any mounting strip. The bent end part of the seal 805 is secured to one of the edges of the door seal (i.e. on the hinge edge or the leading edge) 806 by means of one of the facade screws. The bending angle can also be about 60-180 degrees. If the angel is very different from 90 degrees such as about 180 degrees it will, however not be possible to secure the bent end part 805 to the edge of the door leaf. A bent end part with a bending angle of about 180 degrees can instead be secured A) to the unbent main part of the door seal or B) to the side of the door leaf, where the unbent main part of the door seal is mounted. An about 180 degrees bend may be in the whole width of the door seal but may also be limited to the lowermost part of the door seal e.g. the lowermost 25, 15 or 10 mm, in which case the bent lowermost part must in some way must be separated from the uppermost part of the door seal e.g. by cutting away the corresponding uppermost part. One end part can be bent in one angle e.g. an angle of about 90 degrees, while the other end part is bent in another angle e.g. an angle of about 180 degrees. It is of course also possible to have both end parts bent in the same angle.

The mounting of a bent end part of the door seal on an edge of the door leaf provides the added advantage that it seals the part of the threshold gap between the edge in question and the threshold bottom surface. This is especially of importance, when there is a gap of 6 mm or more between A) the hinged edge or the leading edge in question and B) the adjacent door jamb, as such a gap provides sufficient space for a mouse to pass through the gap and thereafter under the edge of the door leaf.

On FIG. 8 the end part 807 of the door seal 801 protrudes beyond the door leaf 804 and can seal the lower part of the gap between the door leaf and the adjacent door jamb (not shown). When the door seal 801 is mounted on the front of the door leaf, the protruding end part 807 may overlap the lock jamb but should not overlap the hinge jamb as such an overlap may cause problems when the door is opened and closed. It is the other way around when the door seal 801 is mounted on the backside of the door leaf.

The friction between wires and outer flexible material may also be increased in order to solve or reduce the problem if at least a part of at least one of the metal wires is provided with 3 or more stable bends e.g. stable bends selected from: a) a curve-shaped bend, b) a bulging deformation, c) a wave-shaped bend and d) a wave-like deformation. This solution to the problem is very effective and far more effective than some the other solutions, which are only capable of reducing the problem. The solution with metal wires provided with 3 or more stable bends is therefore preferred. It may be combined with one or more of the other above strategies for reducing or solving the problem.

The number of said metal wires (300) provided with said stable bends may be at least 1, such as at least 2, such as at least 3, such as at least 4, such as at least 5, such as at least 7, such as at least 9.

Said stable bends may be evenly distributed over the whole length of the wire (300).

When the bends are wave-shaped, one bend shall be considered to correspond to one wave i.e. spanning one whole wave-length. When the beds are not wave-shaped, one bend shall be considered to be whatever looks most like a wave-shaped bend.

The number of said bends of said metal wires (300) may be at least 3 such as at least 5, such as at least 10, such as at least 15, such as at least 20, such as at least 30, such as at least 40, such as at least 50, such as at least 70, such as at least 100, such as at least 150, such as at least 200.

The number of said stable bends per meter metal wire (300) may be at least 3 such as at least 5, such as at least 10, such as at least 15, such as at least 20, such as at least 30, such as at least 40, such as at least 50, such as at least 70, such as at least 100, such as at least 150, such as at least 200.

When said stable bends are wave-shaped the peak amplitude measured from the core of the wire (300) may be at least 0.05 mm, such as at least 0.1 mm, such as at least 0.15 mm, such as at least 0.2 mm, such as at least 0.25 mm, such as at least 0.4 mm, such as at least 0.7 mm, such as at least 1 mm, such as at least 1.5 mm, such as at least 2 mm.

When said stable bends are wave-shaped the peak amplitude measured from the core of the wire (300) may be no more than 10 mm, such as no more than 8 mm such as no more than 6 mm, such as no more than 4 mm, such as no more than 3 mm, such as no more than 2 mm, such as no more than 1 mm.

When said stable bends are wave-shaped the wavelength of the waves may be at least 2 mm, such as at least 3 mm, such as at least 4 mm, such as at least 5 mm, such as at least 6 mm, such as at least 7 mm, such as at least 10 mm, such as at least 12 mm, such as at least 15 mm.

When said stable bends are wave-shaped the wavelength of the waves may be no more than 30 mm, such as no more than 25 mm such as no more than 20 mm, such as no more than 15 mm, such as no more than 10 mm, such as no more than 8 mm.

When said stable bends are not wave-shaped the measure corresponding to the peak amplitude of a wave-shaped bend measured from the core of the wire may be at least 0.05 mm, such as at least 0.1 mm, such as at least 0.15 mm, such as at least 0.2 mm, such as at least 0.25 mm, such as at least 0.4 mm, such as at least 0.7 mm, such as at least 1 mm, such as at least 1.5 mm, such as at least 2 mm.

When said stable bends are not wave-shaped the measure corresponding to the peak amplitude of a wave-shaped bend measured from the core of the wire may be no more than 10 mm, such as no more than 8 mm such as no more than 6 mm, such as no more than 4 mm, such as no more than 3 mm, such as no more than 2 mm, such as no more than 1.5 mm.

When said stable bends are not wave-shaped the measure corresponding to the wavelength of a wave-shaped bend may be at least 2 mm, such as at least 3 mm, such as at least 4 mm, such as at least 5 mm, such as at least 6 mm, such as at least 7 mm, such as at least 10 mm, such as at least 12 mm, such as at least 15 mm.

When said stable bends are not wave-shaped the measure corresponding to the wavelength of a wave-shaped bend may be no more than 30 mm, such as no more than 25 mm such as no more than 20 mm, such as no more than 15 mm, such as no more than 10 mm, such as no more than 8 mm.

When said stable bends are wave-shaped the ratio between the abovementioned number of bends per meter and the abovementioned peak amplitude measured from the core of the wire may be such that the result of a multiplication of said number of bends per meter and said peak amplitude in mm is A) a number in the range of 5-200, such as 10-150, such as 20-100, such as 40-80, such as 50-60 or B) a number in the range of 5-100, such as 10-60, such as 20-40, or C) a number in the range of 70-95.

When said stable bends are not wave-shaped the ratio between the abovementioned number of bends per meter and the abovementioned measure corresponding to the peak amplitude of a wave-shaped bend measured from the core of the wire may be such that the result of a multiplication of said number of bends per meter and said measure in mm is A) a number in the range of 5-200, such as 10-150, such as 20-100, such as 40-80 such as 50-60 or B) a number in the range of 5-100, such as 10-60, such as 20-40, or C) a number in the range of 70-95.

FIG. 9 is a perspective view of a flexible seal 901 similar to the seals of FIGS. 1 and 2 with a flexible outer material 902 but provided with several of the abovementioned stable bends of the wires 903 and with similar stable bends of the flexible outer material 902. The bends may be in the form of bulging or wavelike deformations 904 compared to the flexible outer material 102a, 102b, 202a and 202b and the wires 103 and 203 of the seals 101 and 201 of FIGS. 1 and 2. The bends of the flexible outer material and the embedded wires may be substantially identical or just uniform.

Said bends 904 extend substantially perpendicular to a plane defined by the lengthwise and width-wise directions of the door seal 901.

Minimum bends e.g. in the form of bulging or wavelike deformations of an embedded metal wire 903 is needed in order to maintain the position of the metal wire 903 within the flexible material 902. For the seal 901 of FIG. 9, the bends 904 has a top part 905 and a bottom or lower part 906 with a height difference between the highest point of the top part 905 and the lowest point of the bottom or lower part 906—measured on the visible same side of the edge of the flexible outer material 902. Here, the difference in height between the top part 905 and a consecutive bottom part 906 should be at least ½ of the diameter or thickness of the metal wire 903, such as at least ¾ of the diameter or thickness, such as at least the measure of the diameter or thickness, or such as at least 1½ of said diameter or thickness.

If the height difference of said bends e.g. in the form of bulging or wavelike deformations 904 gets too large, the metal wire 903 may work itself through the flexible material 902 surrounding the wire 903. Partly because of this, it is preferred that the difference in height between a top part 905 and a consecutive bottom part 906 is no larger than 5 times the diameter or thickness of the metal wire, such as no larger than 4 times the diameter or thickness, such as no larger than 3 times the diameter or thickness.

In order for the metal wire 903 to be held in position within the seal 901, the distance from one bend e.g. wavelike deformation 904 to the neighbouring bend e.g. wavelike deformation shall not be too large. Partly because of this, it is preferred that the distance between two neighbouring tops 905 of the bulging or wavelike deformations 904 is no larger than 20 times the diameter or thickness of the metal wire 903, such as no larger than 17 times the diameter or thickness, such as no larger than 15 times the diameter or thickness, such as no larger than 12 times the diameter or thickness, or such as about 8 times the diameter or thickness.

If the distance from one of said bends 904 to the neighbouring bend gets too small, the metal wire 903 may work itself through the flexible material 902. Partly because of this, it is preferred that the distance between two neighbouring tops 905 of the bends 904 is at least 4 times the diameter or thickness of the metal wire 903, such as at least 5 times, such as at least 6 times.

The seal 901 of FIG. 9 may be obtained by first producing a flat and straight seal similar to the seals of FIGS. 1 and 2 and thereafter to pass it between 2 corrugating rollers in order to provide it with wave-shaped bends or wave-like deformations.

The seal 501 in FIGS. 5 and 6 may be a seal (901) with the above described wires (300 and 903) with stable bends. The mounting strip 506 (also called “connecting Plate”) in FIGS. 5 and 6 may be a mounting strip (FIG. 11a-11g) according to any of the of the implementation forms of the 5th aspect.

The metal wires (300 and 903) mentioned in all the above implementation forms of the 2^{nd} aspect may also be A) narrow metal strips or B) combinations of metal wires and narrow metal strips.

### Example 4.G.2

A specific implementation form of the flexible door seal of this 2^{nd} aspect could be a 3.2 mm thick, 62 mm broad and 1 m long extruded blade door seal with a flattened form and substantially uniform thickness for rodent proofing the threshold gap under the door leaf of a manual single hinged swing door in a building,
1) with the flexible outer material of both the sealing section and the mounting section made out of Santoprene™ 201-73 and with a Shore A score of 78,
2) with a ratio between the thickness in mm and the Shore A score of 250,
3) with 5 solid single stranded wires with a diameter of 1 mm made of stainless-steel, primed with a primer suitable for improving the adhesion of the flexible outer material on the stainless-steel,
4) with a 35 mm broad sealing section, wherein 5 of said wires are embedded in such a way
   a) that they all are parallel to the longitudinal direction of the door seal,
   b) that they all are placed in the same plane at a distance of about 1.1 mm from the 2 broad sides,
   c) that the distance between the wires is uniform and the distance from a wire to the neighboring wire(s) is 5 mm, and
   d) that the distance from the lowermost wire (203) to the lower edge of the door seal (201) is 3 mm,
5) with a 27 mm broad mounting section with no embedded wires,
6) with all said 5 wires provided with 70 stable and uniformly wave-shaped bends per meter,
   a) where the peak amplitude is 1.11 mm and the wavelength is 12 mm,
   b) where the waves extend substantially perpendicular to a plane defined by the lengthwise and widthwise extension of the door seal, and
   c) where the ratio between the number of bends per meter and the peak amplitude is 78, and
7) With 10 sets of two markings in the form of imprints in the outer flexible material said sets of markings indicating recommended positions for placing fasteners
   a) with said sets of markings placed uniformly at a 10 cm distance in the longitudinal direction of the seal between two neighboring sets,
   b) with one marking in the upper part of the seal and one marking in the lower part of the seal,
   c) with each marking between two neighboring metal wires, and
   d) with a continuous band of letters substantially in the middle between the 2 longitudinal edges of the seal

### H. 3rd Aspect—Use of Flexible Seal for Sealing a Door in a Building, a Wall or a Fence

The third aspect of the disclosed embodiments is a method of one or more of the following:
1) Securing the threshold gap of a hinged swing door, a bifold door, a folding door or a rotating door in a building, a wall or a fence against pests such as rats and mice.
2) Preventing water from entering through threshold gaps in said doors in a building, a wall or a fence.
3) Limiting air drafts through gaps between a door leaf of a door in a building and a surface adjacent to the door leaf e.g. said threshold gaps of said doors and thereby making it easier to control the temperature in a room behind the door.
4) Protecting
   a) the lower part of the backside of a door leaf of a hinged swing door,
   b) the lower part of the front of the door leaf of a hinged swing door,
   c) the lower part of a door leaf of a bifold door,
   d) the lower part of a door leaf of a folding door, or
   e) the lower part of a door leaf of a rotating door
      against damaging or destructive forces such as the impact from being hit by a pallet lifter,
      said method comprising the step of mounting a blade seal according to any one of the implementation forms of the 1st and 2^{nd} aspects on the door.

The threshold gap may be 1-50 mm high, such as 5-40 mm high, such as 5-35 mm, such as 10-30 mm. The door may be an exterior or an interior door.

The method may comprise one or more of the following steps:
1) Mounting at least a part of the blade seal on the front of a door leaf.
2) Mounting at least a part of the blade seal on the backside of a door leaf.
3) Mounting at least a part of the blade seal on the hinged edge of a door leaf of a hinged door.
4) Mounting at least a part of the blade seal on the leading edge of a door leaf of a hinged door.
5) Mounting at least a part of the blade seal by means of a mounting strip of any of the implementation forms of the 5th aspect of the disclosed embodiments e.g. a strip with a chamfered or beveled end piece and an oversized predrilled hole close to said end piece.
6) Mounting the blade seal in order to seal a threshold gap.

The method may also comprise one or more of the following steps:
1) At least one end part of the blade seal is bent in an angle of 60-120 degrees preferably about 90 degrees, and the bent end part is thereafter secured to the hinged edge of the door leaf or the leading edge of the door leaf—e.g. by a rivet, a screw, a screw bolt or another fastener.
2) At least a part of an end part of the blade seal is bent in an angle of 150-180 degrees preferably about 180 degrees and the bending angel is thereafter secured a) by fastening the bent end part to the door leaf—e.g. by a rivet, a screw, a screw bolt or another fastener—or b) by fixating the bent end part to the main part of the blade seal—e.g. by a rivet, a screw bolt, a cable tie, a clip or another fastener.

When the door is a double swing door the method may comprise the step of mounting 2 seals according to the 2^{nd} aspect horizontally on the bottom parts of the 2 door leaves of the double door in order to seal the 2 threshold gaps under the 2 door leaves, in such a way that the end parts of the seals at least partly overlap where they meet in the middle of the double door when both door leaves are closed thereby closing at least a part of the gap between the two threshold gaps (i.e. the space under the bottom of the astragal gap between the two door leaves) and possibly also the lowermost part of the astragal gap. The 2 door seals may likewise be mounted so they adjoin instead of overlapping.

When the door is a single swing door the method may comprise the step of mounting a blade seal horizontally at the bottom of the door leaf in such a way A) that said door seal is mounted on the front of the door leaf and protrudes from the leading edge of the door leaf and overlaps at least a part of the lock jamb of the door or B) that said door seal is mounted on the backside of the door leaf and protrudes from the hinged edge of the door leaf and overlaps at least a part of the hinge jamb of the door.

When using a mounting and shielding strip with a chamfered or beveled end piece, and the door is a hinged swing door, the method may comprise the step of placing said end piece adjacent to the hinge door jamb, on which the door leaf is hinged.

When using a mounting and shielding strip with a chamfered or beveled end piece with an oversized predrilled hole close to said end piece, and the door is a hinged swing door, the method may comprise the following: A) placing said end piece adjacent to the hinge door jamb, on which the door leaf is hinged and B) using an oversized screw or rivet in said oversized predrilled hole. Alternatively the method may comprise the step of mounting a screw bolt through a predrilled hole close to said end piece and through the door leaf with a corresponding nut on the opposite side of the door leaf.

### Example 4.H.1

A specific embodiment of the method could comprise
1) mounting the blade door seal of example 4.G.2 on the backside of the door leaf of a manual exterior single hinged swing door in a building by means of the mounting and shielding strip of example 4.J.1 in order
   a) to rodent proof a 25 mm high threshold gap
   b) to prevent water from entering through the threshold gap
   c) to limit air drafts through the threshold gap and thereby making it easier to control the temperature in the room behind the door and
   d) to protect the lower part of the backside of the door leaf against damaging or destructive forces,
2) using an oversized screw with a diameter of 8 mm in the predrilled 8 mm hole in the mounting and shielding strip and screws with a diameter of 5 mm in the other predrilled holes, and
3) placing the beveled end surface of the mounting and shielding strip closest to the hinge door jamb, on which the door leaf is hinged, and the other end of the mounting and shielding strip farthest away from said hinge door jamb.

### I. 4th Aspect—Method for Producing a Flexible Blade Seal with Bent Metal Members

The type of door seals of the 2^{nd} aspect where at least a part of at least one of the metal members e.g. metal wires is provided with 3 or more stable bends e.g. bends selected from: a) a curve-shaped bend, b) a bulging deformation, c) a wave-shaped bend and d) a wave-like deformation may according to a fourth aspect be produced by first producing a flat and straight seal e.g. a seal similar to the type of seals shown in FIGS. 1 and 2 and thereafter to pass the seal between a pair of corrugating rollers in order to provide the seal and the embedded metal members with stable wave-shaped bends or wave-like deformations. If a door seal with one or two flat and straight surfaces is preferred instead of a door seal with two wave-shaped or wave-like surfaces, one or both of the wave-shaped or wave-like surfaces may be provided with additional flexible outer material e.g. by means of an extrusion process or an insert molding process. Thus, a corrugated door seal with two wave-shaped or wave-like surfaces may be passed through an extruder, where the cross section of the inlet part corresponds to the thickness and breadth of the corrugated door seal, and the cross section of the outlet part is identical to or a little thicker than the cross section of the inlet part. After passing through the extruder all the curves of the door seal will be filled up with additional flexible material. Such a door seal with flat and straight surfaces may be advantageous e.g. if a door seal mounted by means of a mounting strip has been worn out or damaged and the seal is to be reused by inverting the seal, so the sealing section becomes the mounting section and the mounting section becomes the sealing section. This is because the former mounting section could have been deformed by the pressure from the mounting strip if it had been wave-shaped instead of flat and straight.

FIG. 10 shows a processing system 1000 for forming a number of stable bends e.g. bulging or wavelike deformations in a flat and straight door seal—e.g. a seal similar to the type of seals shown in FIGS. 1 and 2—and the metal members embedded therein. The processing system 1000 comprises two toothed gear-wheels or corrugating rolls 1001 and 1002, each holding a number of roller teeth 1003 and 1004, wherein the two gear-wheels or corrugating rolls 1001, 1002 are arranged for rotating around two parallel axes 1003 and 1004, with the gear-wheels or corrugating rolls 1001, 1002 facing each other with at least partly interconnecting teeth 1003, 1004 e.g. 0.6 mm interconnecting teeth. The system 1000 further holds a feed support 1007 positioned for directing the door seal between the teeth 1003, 1004 of the two gear-wheels or corrugating rolls 1001, 1002 with the embedded metal wires extending substantially perpendicular to the rotation axes. The system 1000 may also hold a seal output support 1008 positioned for supporting the now deformed door seal 1009 coming out from the deforming gear-wheels or corrugating rolls 1001, 1002. In order to avoid damage to the door seal, the teeth 1003, 1004 of the gear-wheels or corrugating rolls 1001, 1002 should preferably have a rounded outer edge. The diameter of the corrugating rolls may be 5-20 cm, such as around 10-15 cm, such as around 13 cm. The number of teeth of one of the rolls may be 25-35 such as around 30.

The flat and straight seal 1010 may be placed on the feed support 1007 between the teeth 1003, 1004 of the two gear-wheels or corrugating rolls 1001, 1002 with the embedded metal members e.g. wires extending substantially perpendicular to the rotation axes 1005, 1006. The flat and straight seal 1010 can then be passed between the at least partly interconnecting teeth 1003, 1004 of the two gear-wheels or corrugating rolls 1001, 1002 while these are rotated, whereby pressure is provided on both sides of the seal 1010 by the teeth 1003, 1004 of the gear-wheels or corrugating rolls 1001, 1002. This pressure provides a number of consecutive bends e.g. bulging or wavelike deformations in the now deformed seal 1009. The conveying speed may be 10 cm to 20 meter per minute such as 20 cm to 5 m per minute, such as around 1 meter per minute.

The exact configuration of the method will depend a lot on the dimensions and other qualities of the flat and straight seal. What is said above is at least relevant to the seal described in example 4.G.2.

The abovementioned flat and straight seal may have been produced by an extrusion process or by insert molding. How to do that is described in the 2 PCT applications PCT/DK/2017/050400 (WO/2018/099532) and PCT/DK/2017/050401 (WO/2018/099533)

In a possible implementation form of the fourth aspect, the flat and straight seal has been produced by an extrusion process or an insert molding process comprising the following step: At least one of the elongated metal members is heated to a temperature in the range of 175 to 225° C. before A) being fed into the extruder die or B) placed in the insert molding die.

The purpose of the heating of the elongated metal members is to secure a better attachment of the flexible outer material to the elongated metal members.

In a possible implementation form of the fourth aspect at least one of the metal members of the flat and straight seal is a solid single stranded metal wire, a multi stranded metal wire or a solid narrow metal strip which is at least partly deformed, roughed, surface treated or primed—e.g. at least partly fluted or grooved, chemically treated or etched, sandblasted, glass bead blasted, shot blasted, chromate coated, coated by a deformed coating material, coated by an adhesive coating, such as a brass alloy coating or coated by a primer coating such as a zinc chromate primer—before being embedded in the flexible outer material during the extrusion or insert molding process.

### J. 5^{th} Aspect—A Separate Mounting Strip for Mounting a Door Seal and an Assembly of the Mounting Strip and a Flexible Door Seal

FIGS. 11a, 11 b and 11c show separate mounting strips for mounting a door seal according to any of the implementation forms of the first and second aspects of the present disclosure on a door leaf, another building part, a wall or a fence. It may also be used for mounting other flexible door seals. The mounting strip may be assembled with a flexible door seal creating an assembly comprising the mounting strip and a door seal e.g. a door seal according to any of the implementation forms of the first and second aspects of the present disclosure.

FIG. 11a shows a separate mounting strip 1101 with pre-drilled mounting holes 1102. The distances a) between the 5 leftmost mounting holes b) between the leftmost mounting hole and the left edge and c) between the rightmost mounting hole and the right edge are relatively small. Said relatively small distances could be 1-8 cm, such as 2-6 cm, such as about 3-5 cm. The length of the mounting strip 1101 could be at least 80 cm, such as at least 85 cm, such as at least 90 cm, such as at least 95 cm, such as at least 100 cm, such as at least 150 cm, such as at least 175 cm, such as at least 200 cm or such as at least 225 cm. The number of predrilled mounting holes 1102 in a mounting strip 1101, which is 80-100 cm long, could be 5-19, such as 8-15, such as 10-12. The number of predrilled mounting holes 1102 in a mounting strip 1101, which is between 190 cm long and 250 cm long, could be 7-30, such as 10-25, such as 15-20. The width of the mounting strip 1101 may be 20-80 mm, such as 25-60 mm, such as 30-50 mm, such as about 40 mm. The thickness of the strip 1101 may be 2-5 mm, such as 2-4 mm, such as about 3 mm. It may be made of a hard polymer material or a metal such as aluminum, iron, steel, stainless steel or spring steel. A mounting strip of spring steel is flexible and can therefore bend a little when e.g. a pallet lifter collides with the mounting strip. This is an advantage because it can reduce the risk that such collisions will break one or more of the fasteners—e.g. screws or rivets—with which the mounting strip is mounted.

The number of pre-drilled mounting holes 1102 in the 20 cm of the mounting strip 1101 closest to one of the ends of the mounting strip may be at least 3, such as at least 4, such as at least 6, such as at least 8. The distance between at least one of said at least 3 holes and the neighboring hole in the said 20 cm may be 1-8 cm, such as 2-6 cm, such as about 3-5 cm. The distance between the ends of the mounting strip and the hole closest to the end may be 1-8 cm, such as 2-6 cm, such as about 3-5 cm.

When adapting the length of the mounting strip 1101 to the dimensions of the door leaf, the other building part, the fence or the wall, on which it is to be mounted, the user can cut off the relevant part of the (left) end with the high concentration of holes and be relatively sure to have a useful mounting hole conveniently close to both ends of the mounting strip.

FIG. 11b shows the separate mounting strip of FIG. 11a seen from above.

FIG. 11c shows a separate mounting strip 1103 similar to the mounting strip 1101 of FIG. 11a with pre-drilled mounting holes 1104 except A) that the seal has been provided with additional predrilled mounting holes, and B) that each predrilled mounting hole has at least one relatively close neighboring predrilled mounting hole at a distance of no more than 8 cm, such as no more than 5 cm, such as no more than 3 cm, such as no more than 2 cm, such as no more than 1 cm.

The separate mounting strips 1101 and 1103 may be reused for mounting a new seal on the same surface (the mounting surface), when the seal already mounted by means of the mounting strip it to be replaced e.g. because the old seal has been worn out or damaged. The mounting strips 1101 and 1103 may be reused several times in this way. However, there is a limit to how many times the mounting strip 1101 and 1103 can be reused in this way using the same screw or rivet mounting holes in the surface, on which the seal and the mounting strip 1101 and 1103 is mounted. When such screw or rivet holes are worn out and can no longer be reused, it is, therefore, desirable that there are alternative predrilled mounting holes 1105 in the mounting strip close to the holes used for originally mounting the seal and the mounting strip 1103 on said surface, as this makes it easy to reuse the mounting strip 1103 in the described way with a new set of fresh mounting holes in said surface corresponding to the alternative mounting holes 1105 in the mounting strip 1103. Having such close alternative holes 1105 at least doubles the number of times, in which the mounting strip 1103 can be reused on the same surface in the described way.

It is preferred that the pre-drilled mounting holes 1101, 1104 and 1105 of the separate mounting strips of FIGS. 11a and 11c are placed substantially on a line in the middle between the 2 longitudinal edges of the mounting strips 1101 and 1103, so the problem with worn out mounting holes in the mounting surface in many instances may also be solved simply by rotating the mounting strip 1101 and 1103 about 180 degrees so A) the two end parts of the mounting strip exchange mounting positions and the position of the rotated mounting strip (except for the rotation) substantially is the same both in relation to the mounting surface and the seal and B) all the predrilled mounting holes 1102, 1104 and 1105 change positions in relation to the mounting surface without there being a high risk that the new positions of the pre-drilled mounting holes 1102, 1104 and 1105 end up in positions, where it is undesirable to place new mounting screws or rivets in the mounting surface, on which the new seal is to be mounted.

The mounting strips serve a dual purpose as they do not only fixate the door seal to the door leaf but also protect both the door leaf and the door seal against colliding pallet lifters and other sorts of violent impact which may damage the door leaf and/or the door seal.

When the door leaf of a hinged swing door in a building has been provided with a door seal and a mounting and shielding strip on the backside of the door leaf in order to seal the horizontal threshold gap under the door leaf, and the door is open, there is a risk that the mounting and shielding strip (1101 or 1103) will be damaged e.g. bend if the end-surface (1106) of the mounting and shielding strip closest to the hinge door jamb, is hit by e.g. a heavy pallet lifter.

FIGS. 11d-11g show an end piece of a mounting and shielding strip where that risk has been reduced by chamfering or beveling one end surface of the mounting and shielding strip and to mount that end closest to the hinge door jamb. The angle between the new chamfered or beveled surface (1107 and 1108) and the original end surface (1109) may be at least 30 degrees, such as at least 40 degrees, such as at least 50 degrees, such as at least 60 degrees, such as at least 70 degrees.

The risk may also be reduced A) by using oversized fasteners for fixating said end of the mounting and shielding strip on the door leaf e.g. by oversized screws or rivets with a diameter of at least 6 mm, such as at least 7 mm, such as at least 8 mm, such as at least 9 mm, such as at least 10 mm and ii) a diameter being at least and B) by making the predrilled hole (1110) or the two predrilled holes closest to said end surface correspondingly oversized e.g. to provide it (1110) or them with a diameter of at least 6 mm, such as at least 7 mm, such as at least 8 mm, such as at least 9 mm, such as at least 10 mm. Screws, rivets and predrilled holes shall in this context been seen as “oversized” if their diameter exceeds the average diameter of the majority of the used screws or rivets or the predrilled holes by at least 2 mm, such as at least 3 mm, such as at least 4 mm such as at least 5 mm. Another way of reducing the risk is to use a screw bolt and a corresponding nut with the screw bot going through the door leaf and the head of the screw bolt and the nut on opposite sides of the door leaf. The diameter of such a screw bolt could be at least 5 mm, such as at least 6 mm, such as at least 8 mm, such as at least 10 mm.

The risk of the mounting strip being hit and damaged by e.g. a pallet lifter may, be reduced by the addition of warning colors on at least a part of the mounting strip e.g. in the form of A) one or more warning colors painted on the mounting strip or B) warning colored tape taped on the mounting strip. Warning colors shall in this connection be understood as colors and combinations of colors usually used for warning purposes such as conspicuous, intense and bright colors e.g. red, orange or yellow and combinations of such colors and other colors e.g. stripes of yellow and black.

It is preferred that the predrilled holes are countersunk holes for countersunk screws as the use of countersunk screws will reduce the risk for the screw heads getting knocked off e.g. when hit by a pallet lifter.

### Example 4.J.1

A specific implementation form of the separate mounting and shielding strip of this 5th aspect could be
a 3 mm thick, 4 cm wide and 100 cm long mounting strip of stainless-steel with 12 predrilled countersunk mounting holes placed substantially on a line in the middle between the 2 longitudinal edges of the mounting strip and respectively 2.5, 5, 7, 5, 10, 12.5, 15, 41, 43, 68, 70, 96 and 98 cm from one of the ends of the mounting strip,
with a beveled end surface as shown in FIGS. 11f-11g in the end of the strip with the lowest density of predrilled holes, where the angle between the new beveled surface (1108) and the original end surface (1109) is 60 degrees, the remaining part of the original end surface (1109) is 1 mm, and the predrilled hole (1110) closest to said beveled end surface (1108) is oversized and has a diameter of 8 mm, while the average diameter of the other predrilled holes is less than 6 mm,
for mounting the rodent proofing door seal of example 4.G.2 in order to seal the threshold gap of a manual single swing door and for protecting the lowermost 10-35 mm of the backside of the door leaf, on which the door seal and the mounting and shielding strip is mounted, against damaging force,
where at least a part of the mounting strip has been provided with warning colors in the form of tape with bload stripes in bright yellow and black.

### K. 6th Aspect—a Tool for Mounting a Door Seal and/or a Mounting Strip

When mounting a door seal—e.g. a blade door seal according to the 2^{nd} aspect of the disclosed embodiments—on the bottom part of a door leaf in order to seal the threshold gap under the door leaf it can be difficult for one person at the same time to hold the door seal in place and to fasten it to the door leaf with fasteners such as screws or rivets. That can be even more difficult if the person has to hold both the door seal and a separate mounting strip—e.g. a mounting strip according to the fifth aspect of the disclosed embodiments—in place while fastening both to the door leaf.

FIG. 12a shows a substantially cube shaped tool 1201 for holding a door seal in place during the mounting process—in perspective view. The tool has a width 1202 a height 1203 and a thickness 1204. The tool may have other shapes than cube shaped, but substantially square shaped sides are preferred. The width may be at least 10 mm, such as at least 20 mm, such as at least 30 mm, such as at least 40 mm, such as at least 50 mm, such as at least 60 mm, such as at least 70 mm, such as at least 80 mm. The height may be 10-70 mm, such as 20-60 mm, such as 30-50 mm, such as about 40 mm. The thickness may be 10-70 mm, such as 20-60 mm, such as 30-50 mm, such as about 40 mm.

The width may be 30 to 50 mm, while the height is 30 to 50 mm and the thickness is 30 to 50 mm, In one implementation form the width is 35-45 mm, the height is 35-45 mm and the thickness is 35-45 mm.

At least one of the edges 1205 should be rounded in order to make the tool more user friendly than a tool with sharp edges. Preferably all the edges shall be rounded.

At least one of the corners 1206 should be rounded in order to make the tool more user friendly than a tool with pointed corners. Preferably all the corners shall be rounded.

During the mounting process A) the tool is placed on the ground close to the door seal, B) the door seal is placed between the door leaf and the tool and C) the tool is pressed up against the door seal, so the door seal becomes pressed up against the door leaf and is held in place there. Simultaneous use of 2 or 3 tools placed at a distance of 20-60 cm to each other is preferred.

The tool should be made from a heavy material in order to improve its ability to maintain its position on the ground when holding the door seal in place. Suitable materials are metals including iron, steel, stainless steel and brass. The weight of the tool may be at least 100 g, such as at least 200 g, such as at least 300 g, such as at least 400 g, such as at least 500 g.

FIG. 12b shows in perspective view a similar tool 1207 which has been provided with 2 indenting notches 1208. What is stated above in relation to the FIG. 12a tool applies mutatis mutandis to the FIG. 12b tool. The number of notches 1208 in the FIG. 12b tool is 2 but it could be 1, 2, 3 or 4. The notches 1208 are substantially square shaped but may have different shapes.

The notches have a width 1209 and a height 1210.

When a separate mounting strip—e.g. a mounting strip according to the fifth aspect of the disclosed embodiments—is placed in one of the notches 1208, the mounting strip can be held in place in an elevated position at a distance from the underlying surface corresponding to the total height of the tool 1203 minus the height 1210 of the notch.

When provided with more than 1 notch, the notches may have different measures in order to make the tool more flexible and thereby useful A) for different combinations of door seals and mounting strips and B) under different mounting conditions such as different conditions in relation to unevenness of the underlying surface.

The width 1209 of a notch may be 1-10 mm, such as 2-7 mm, such as 3-6 mm, such as 4-5 mm. The height 1208 of a notch may be 10-60 mm, such as 12-40 mm, such as 14-30 mm, such as 15-25 mm, such as 18-22 mm.

The width 1209 of a notch may be 2 to 7 mm, while the height 1210 of the notch is 15 to 25 mm. In one implementation form the width is 3-5 mm and the height is 18 to 22 mm.

### L. Example 4.L

Three door seals according to the present disclosure were tested for their ability to resist persistent rat attacks. The test was designed and carried out by the independent Danish test institute Danish Technological Institute.

The door seals were (3 mm thick and 75 mm wide) made of Santoprene™ 201-73 (a TPV with a Shore A hardness score of 78) and solid single stranded steel wires with a diameter of 1 mm. These were the sole components of the door seals. Ten parallel steel wires were embedded in the Santoprene flexible outer material to form each door seal. The door seals were produced by simultaneous extrusion of the TPV Santoprene™ 201-73 and the steel wires. The distance between neighboring steel wires was 5 mm. The first steel wire was embedded 3 mm from one of the edges, and the tenth steel wire was embedded 17 mm from the opposite edge.

The 3 door seals were tested on a double swing door of steel with each door leaf mounted on 2 hinges. Each of the door leaves was 85 cm broad. The astragal gap i.e. the distance between the leading edges of the 2 door leaves when closed was 8 mm. A broad steel strip was mounted under the double door. The threshold gap i.e. the distance between the bottom edges of the 2 door leaves when closed and the underlying steel strip was approx. 45 mm.

The two rats used in the test were male rats of average size and in good health conditions. Danish Technological Institute provided the rats.

The bottom of the quadrangular test box, in which the double door was mounted, and in which the test was performed, was 1.8 meter by 1.5 meter. The test box was 0.6 meter high. On top of the box there was a plywood plate with Plexiglas windows, so the rats could be observed without taking off the top plate. Attached to one end of the test box there was a small cage where the 2 rats could sleep. Attached to the opposite end of the box there was another small cage, where food was served during the first week of the 2-week test period (the feeding cage). The double door was mounted in the middle of the test box and divided into 2 halves of equal size. The double door was closed during the entire 2 week test period.

The 3 door seals were mounted on the 2 door leaves by means of 3 mounting strips of stainless steel. The steel strips were 2 mm thick and 38 mm broad. The steel strips were fastened to the door leaves by rivets.

The 2 threshold gaps were covered by 2 door seals mounted horizontally on the bottom of the 2 door leaves. The astragal gap was covered by the 3rd door seal, which was mounted vertically on the active door leaf (i.e. the door leaf to be swung open first when opening the double door). The 2 horizontally mounted door seals partly overlapped with each other, where they met in the middle of the double door. The horizontal overlap was 7 mm.

The length of the 3 door seals was as follows: A) The door seal horizontally mounted on the active door leaf: 860 mm. B) The door seal vertically mounted on the active door leaf: 500 mm. C) The door seal horizontally mounted on the passive door leaf: 855 mm.

The 3 steel strips were mounted on the door leaves in line with the edges of the door leaves so no part of the steel strips covered any part of the astragal gap or the threshold gaps—except the end pieces of the horizontally mounted steel strips, which both covered 3 mm of the lowermost part of the astragal gap (leaving a 2 mm wide vertical gap between the end parts of the 2 steel strips). With the said exception the astragal gap and the threshold gaps were only covered by the door seals. The 2 horizontally mounted seals were mounted with their 17 mm wide sections containing no steel wires upwards. Said 17 mm wide sections were entirely covered by the steel strips—except in the very small part of the astragal gap, where the 2 door seals overlapped without being covered by the mounting strips. The uppermost 30 mm of the 2 horizontally mounted seals constituted the mounting section of said 2 door seals, while the lowermost 45 mm constituted the sealing section.

The test was performed over a 14 days period in May 2017. In the beginning of the test period none of the door seals were mounted. The rats could, therefore, freely pass under the door leaves through the 45 mm threshold gaps.

During the first 7 days, the rats were fed generously in the feeding cage. On day 8 the 3 door seals were mounted. They blocked the rats' access to the half of the test box, where the rats were used to be fed (the feeding half).

The next 7 days, the 2 rats were fed less generously, and they were fed in the half of the test box, where they slept (the sleeping half). Even though the diet was reduced, it was sufficient to keep them in good health and alert. The rats' favorite food such as an open sandwich with eggs and shrimps was placed on the bottom of the feeding half of the test box and a fan was placed behind the food in order to blow the smell of the food through chinks in the double door to the rats in the sleeping half.

The purpose of changing the diet and placing favorite food in the feeding half was to make them interested in overcoming the introduced obstacle between the 2 halves of the test box—i.e. to make them interested in attacking the door seals and entering the feeding half.

The 2 rats did—as they were supposed to—try to gnaw their way through the door seals. The rats succeeded in gnawing off several centimeters of the Santoprene™, but the partly bare steel wires maintained their ability to repel the attacks even though they had been laid open. The rats also attempted to push the horizontally mounted door seals up in order to pass under them, but that attempt was also unsuccessful. The door seals passed the test as the rats did not manage to enter the feeding half with their favorite foods.

### BRIEF DESCRIPTION OF THE DRAWINGS

FIG. 1 is a partially cut away perspective view of a flexible seal.

FIG. 2 is a partially cut away perspective view of a flexible seal.

FIG. 3 is an elongated metal member in the form of a wire with stable bends.

FIG. 4 is a door seal with markings of recommended positioning of fasteners such as screws.

FIG. 5 is an isometric illustration of a lower edge door sealing assembly.

FIG. 6 is an illustration of a part of the lower edge door sealing assembly of FIG. 5.

FIG. 7 is a solid single stranded wire with a deformed uneven surface.

FIG. 8 is door seal with a bend mounted on the lower part of a door leaf with an end part of the door seal protruding from a side of the door leaf.

FIG. 9 illustrate a flexible seal provided with wave-shaped bends.

FIG. 10 illustrates a system for providing a flat and straight flexible seal with wave-shaped bends.

FIGS. 11a, 11 b and 11c show mounting strips for mounting a door seal. FIGS. 11a and 11c are elevation views. In FIGS. 11b and 11g the mounting strip is seen from above.

FIGS. 11d, 11e, 11f and 11g show end pieces of mounting strips with chamfered and beveled end surfaces. FIGS. 11d and 11f are elevation views. In FIGS. 11e and 11g the end pieces are seen from above.

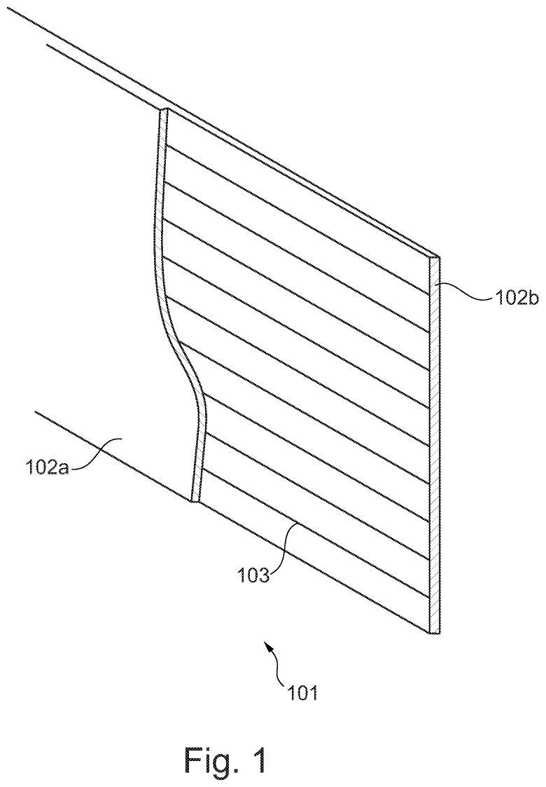

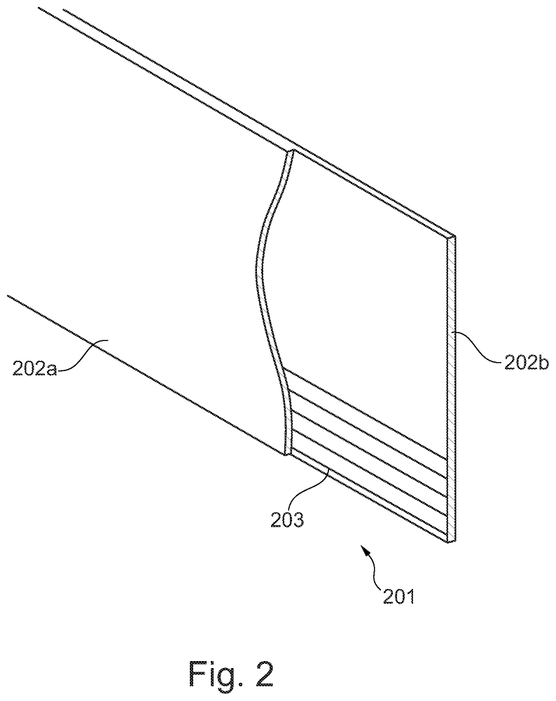

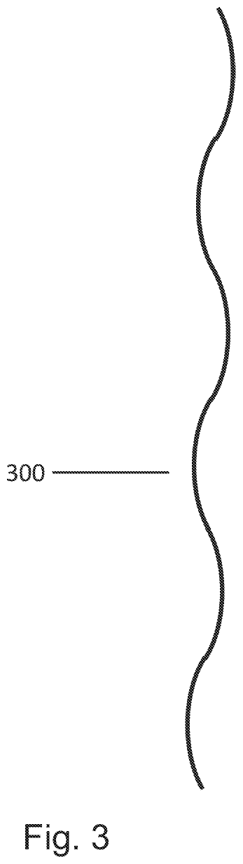

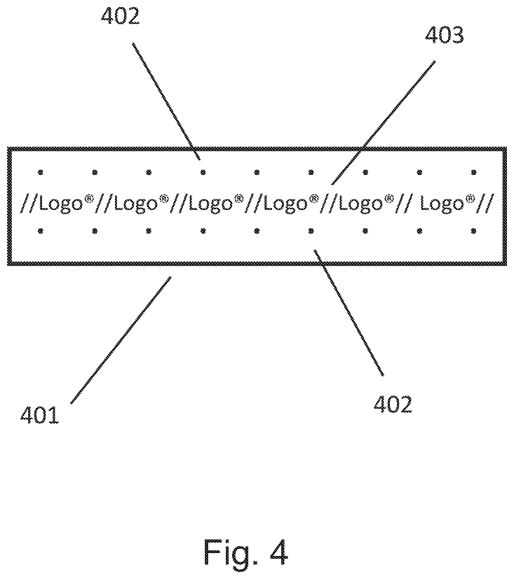

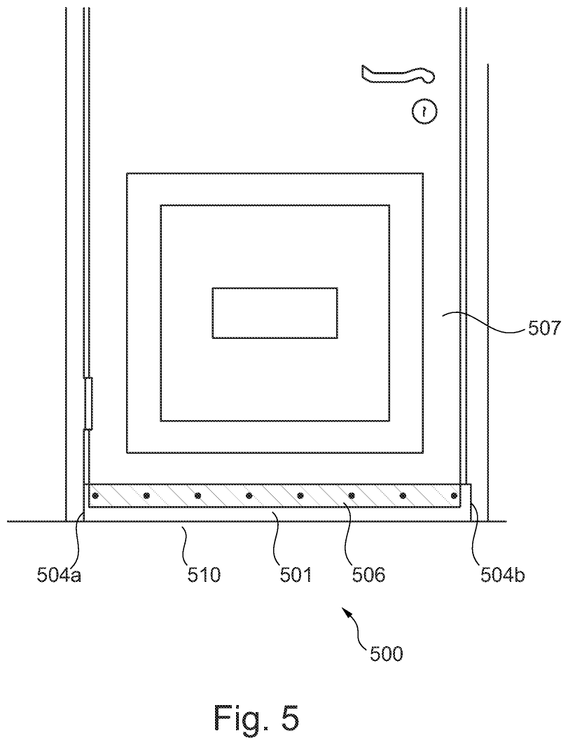

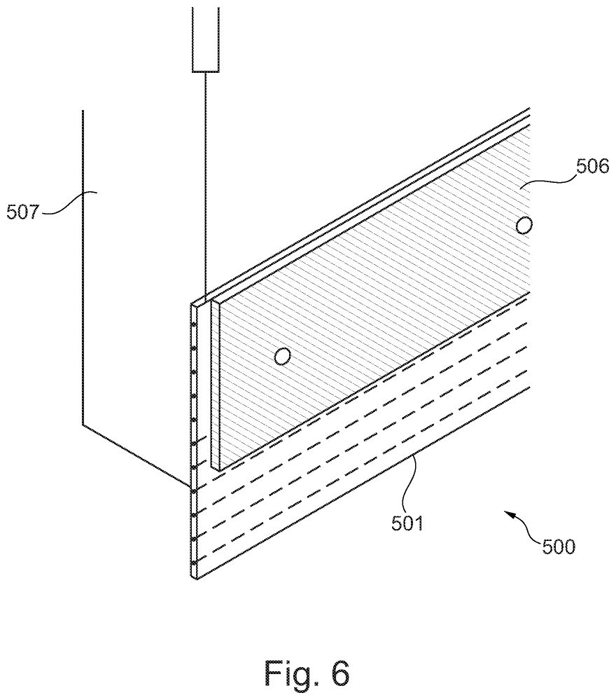

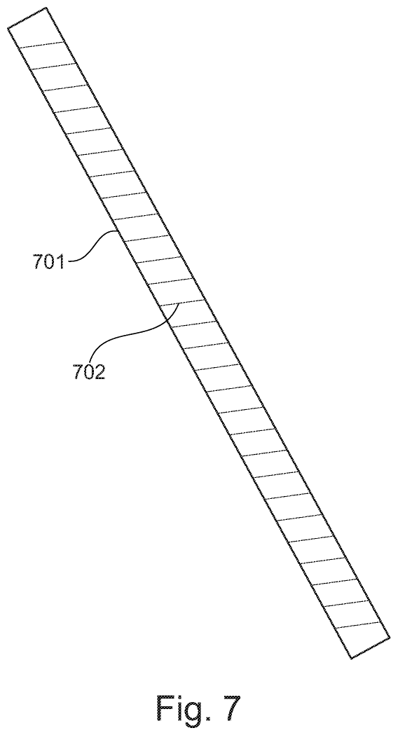

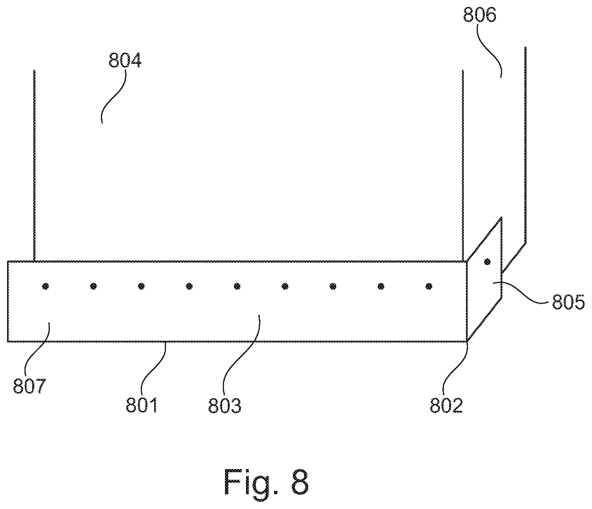

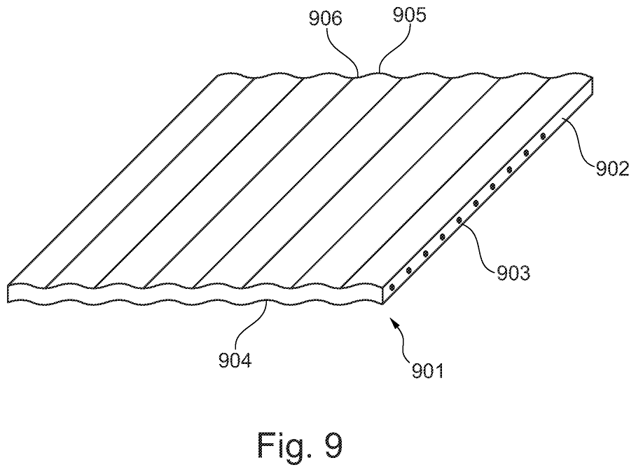

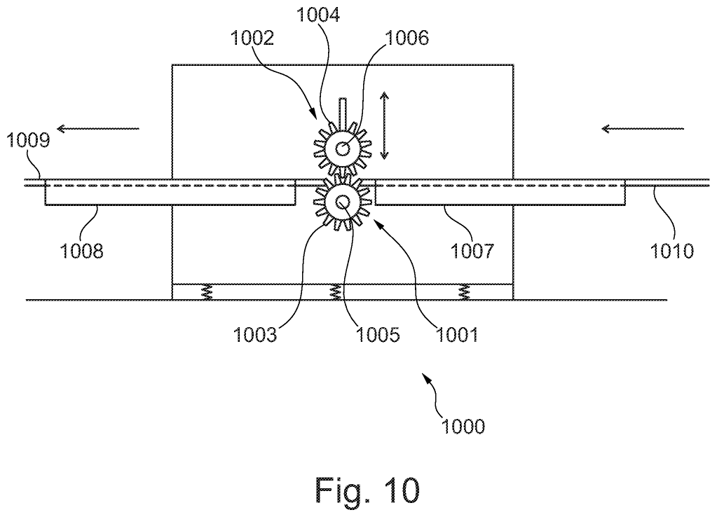

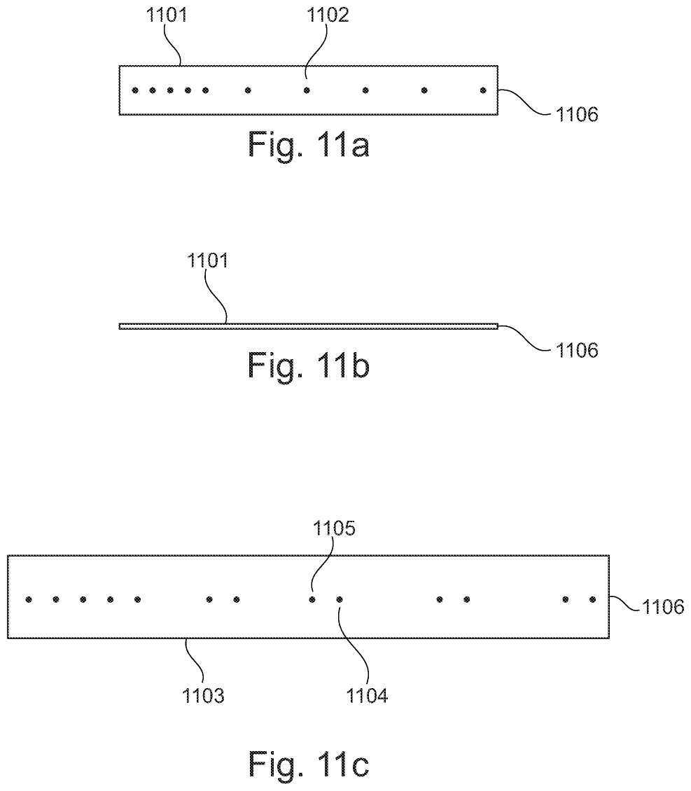

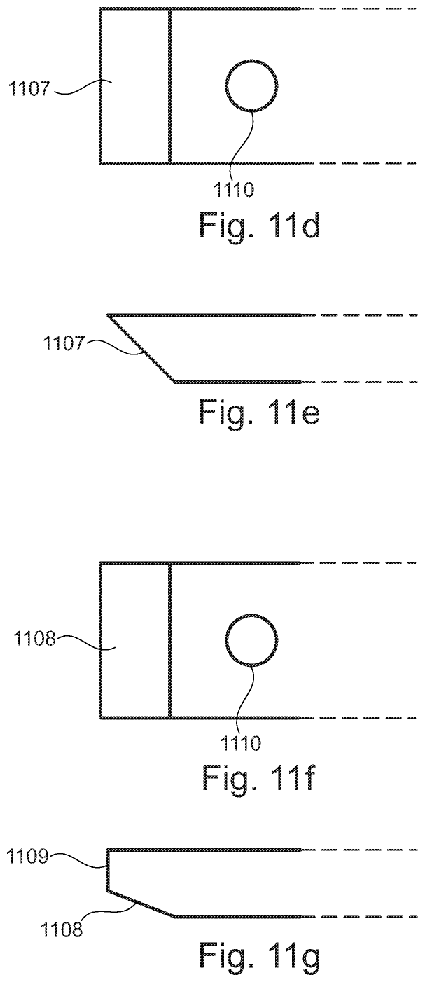

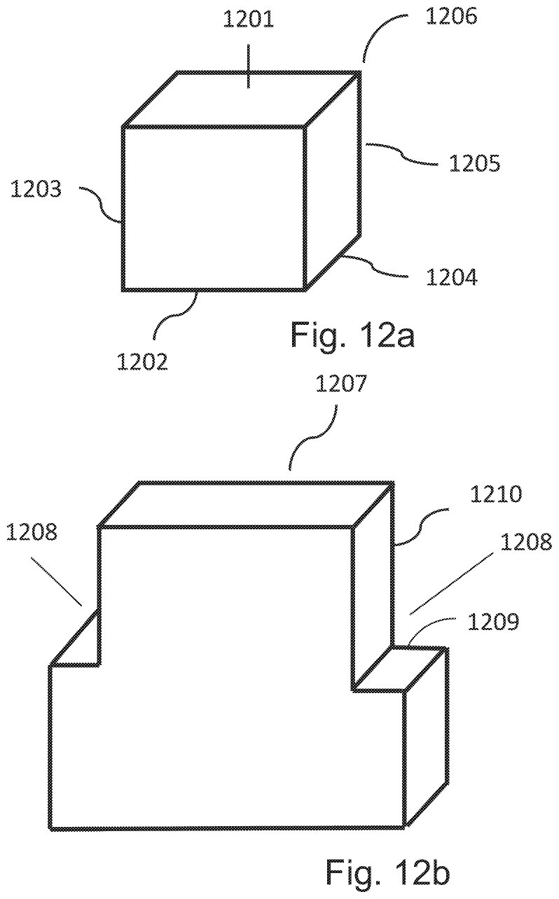

i. FIGS. 12a and 12b show tools for mounting door seals and separate mounting strips in perspective view.

1-12. (canceled)

13. A flexible and oblong blade door seal for sealing a gap between a door leaf and a surface adjacent to the door leaf, said blade door seal having
a sealing section and
a mounting section by means of which the blade door seal can be mounted on the door leaf, said blade door seal comprising
a flexible outer material and
a barrier embedded in at least the part of the flexible outer material corresponding to the sealing section, said barrier comprising a plurality of elongated metal members arranged at a distance to each other substantially in parallel to the longitudinal direction of the oblong blade door seal, where at least a part of at least one of the metal members is provided with at least 5 stable bends per meter metal member e.g. bends selected from: a) a curve-shaped bend, b) a bulging deformation, c) a wave-shaped bend and d) a wave-like deformation.

14. A blade door seal according to claim 13
where the stable bends, when they are wave-shaped, have A) a peak amplitude measured from the core of the elongated metal members of at least 0.1 mm and no more than 10 mm and B) a wavelength of at least 2 mm and no more than 30 mm and
where the stable bends, when they are not wave-shaped, have similar measures corresponding to the said peak amplitude and the said wave-length.

15. A blade door seal according to claim 14
where the stable bends, when they are wave-shaped, have A) a peak amplitude measured from the core of the elongated metal members of at least 0.7 mm and no more than 4 mm and B) a wavelength of at least 6 mm and no more than 20 mm and
where the stable bends, when they are not wave-shaped, have similar measures corresponding to the said peak amplitude and the said wave-length.

16. A blade door seal according to claim 14,
wherein the elongated metal members of the barrier in the sealing section comprises at least two members selected from:
a) an embedded metal wire with a diameter of at least 0.4 mm, and
b) an embedded narrow metal strip with a thickness of at least 0.4 mm and a width of at least 0.6 mm, and
wherein the distance between the adjacent elongated metal members is no larger than 20 mm.

17. A blade door seal according to claim 16,
wherein the elongated metal members of the barrier in the sealing section comprises at least two members selected from:
a) an embedded metal wire with a diameter of at least 0.8 mm, and
b) an embedded narrow metal strip with a thickness of at least 0.4 mm and a width of at least 0.8 mm, and
wherein the distance between the adjacent elongated metal members is no larger than 15 mm.

18. A blade door seal according to claim 17, wherein the elongated metal members of the barrier in the sealing section is made of metals selected from: a) iron, b) steel, c) stainless steel, d) spring steel, and e) welding wire filler metal.

19. A blade door seal according to claim 16 for sealing the threshold gap of a door.

20. A blade door seal according to claim 16, wherein the mounting section comprises a plurality of elongated metal members arranged at a distance to each other substantially in parallel to the longitudinal direction of the oblong blade door seal.

21. A blade door seal according to claim 16, wherein the flexible outer material has a uniform width in the range of 4-10 cm.

22. A blade door seal according to claim 16, wherein the flexible outer material has a flattened form.

23. A blade door seal according to claim 16 integrated in a stiff mounting strip e.g. a connecting plate.

24. A blade door seal according to claim 16 not integrated in a stiff mounting strip.

25. A method of securing a door in a building, a door in a wall or a door in a fence against pests such as rats and mice, said method comprising the step of mounting a blade seal on a door leaf of the door, said blade seal having
a sealing section and
a mounting section by means of which the blade seal can be mounted on the door leaf, said blade door seal comprising
a flexible outer material and
a barrier embedded in at least the part of the flexible outer material corresponding to the sealing section, said barrier comprising a plurality of elongated metal members arranged at a distance to each other substantially in parallel to the longitudinal direction of the oblong blade door seal, where at least a part of at least one of the metal members is provided with at least 5 stable bends e.g. bends selected from: a) a curve-shaped bend, b) a bulging deformation, c) a wave-shaped bend and d) a wave-like deformation.

26. A method according to claim 25,
where the stable bends, when they are wave-shaped, have A) a peak amplitude measured from the core of the elongated metal members of at least 0.1 mm and no more than 10 mm and B) a wavelength of at least 2 mm and no more than 30 mm and
where the stable bends, when they are not wave-shaped, have similar measures corresponding to the said peak amplitude and the said wave-length.

27. A method according to claim 26 where the method is for securing the threshold gap of the door.

28. A method for producing a blade door seal according to claim 13 comprising the step of first producing a flat and straight seal and thereafter to pass the seal between a pair of corrugating rollers in order to provide the seal including the embedded metal members with stable wave-shaped bends or wave-like deformations.

29. A method according to claim 28 comprising the further step of providing the seal with additional flexible outer material in order to make the wave-shaped surfaces flat and straight.

30. A method according to claim 29 where the additional outer material is added by means of an extrusion process or by means of an insert molding process.
